(19) United States
(12) Patent Application Publication
(10) Pub. No.: US 2007/0172338 A1
(43) Pub. Date: Jul. 26, 2007

(54) Folding unloading auger with over center linkage

(76) Inventors: Mark Jeffery Reimer, LeClaire, IA (US); Bryan Scott Claerhout, Colona, IL (US)

Correspondence Address: DEERE & COMPANY, ONE JOHN DEERE PLACE, MOLINE, IL, 61265, US

(21) Appl. No.: 11/338,186

(22) Filed: Jan. 24, 2006

(51) Int. Cl. B65F 9/00

(52) U.S. Cl. 414/339

(57) ABSTRACT

An unloading auger for an agricultural harvester includes an inner auger; an outer auger pivotally coupled with the inner auger; and an over center linkage coupled between the inner auger and the outer auger. The outer auger is movable between an unfolded position and a folded position. The over center linkage is movable to a first over center position when the outer auger is in the unfolded position, and a second over center position when the outer auger is in the folded position.

### FIELD OF THE INVENTION

The present invention relates to agricultural harvesters, and, more particularly, to folding unloading augers in such harvesters.

### BACKGROUND OF THE INVENTION

An agricultural harvester such as a combine includes a head and a feeder housing which remove the crop material from the field, gather the crop material and transport the crop material to a separator. The separator removes the grain crop material from the non-grain crop material. The grain is cleaned and deposited in a grain tank. When the grain tank becomes full, an unloading auger which is folded alongside the combine during harvesting is moved to the unloading position in which the auger extends approximately perpendicular the longitudinal axis of the combine. The combine drives alongside a vehicle into which the grain is to be unloaded, such as a semi-trailer, and the unloading auger is actuated to discharge the grain into the vehicle.

A trend in agricultural machines is for the size of the machines to become larger. One example is the size of the head (such as a bean head) on a combine. Since the combine drives alongside the vehicle into which the grain is to be unloaded, and a larger head means that the body of the combine is a further distance from the vehicle, the length of the auger must also be increased.

It is known to provide a folding unloading auger including an inner auger which folds alongside the combine, and an outer auger which folds around the rear of the combine and rests in a cradle during use. A folding unloading auger prevents the auger from extending an undesirable distance behind the combine when not used during unloading. The outer auger is manually removed from the cradle and moved to the unfolded and engaged position for an unloading operation. The outer auger is locked relative to the inner auger in the unfolded position using a manually operable latch arrangement.

What is needed in the art is a folding unloading auger which can be automatically moved between a folded and unfolded position, is held in the desired position, and positively engages the outer auger at a desired orientation.

### SUMMARY OF THE INVENTION

The present invention provides a folding unloading auger with an over center linkage between the inner auger and outer auger which is lockable in over center positions when the outer auger is respectively in an unfolded position and folded position.

The invention comprises, in one form thereof, an unloading auger for an agricultural harvester, including an inner auger; an outer auger pivotally coupled with the inner auger; and an over center linkage coupled between the inner auger and the outer auger. The outer auger is movable between an unfolded position and a folded position. The over center linkage is movable to a first over center position when the outer auger is in the unfolded position, and a second over center position when the outer auger is in the folded position.

The invention comprises, in another form thereof, a method of operating an unloading auger in an agricultural combine, including the steps of: unfolding an outer auger relative to an inner auger; and moving an over center linkage interconnected between the inner auger and the outer auger to a first over center position when the outer auger is in an unfolded position.

### BRIEF DESCRIPTION OF THE DRAWINGS

FIG. 1 is a perspective view of an agricultural harvester including an embodiment of a folding unloading auger of the present invention;

FIG. 2 is a perspective view of the hinge assembly and over center linkage shown in FIG. 1;

FIG. 3 is a plan view of the over center linkage shown in FIG. 2 when in a folded position; and

FIG. 4 is a plan view of the over center linkage shown in FIGS. 2 and 3 when in an unfolded position.

### DETAILED DESCRIPTION OF THE INVENTION

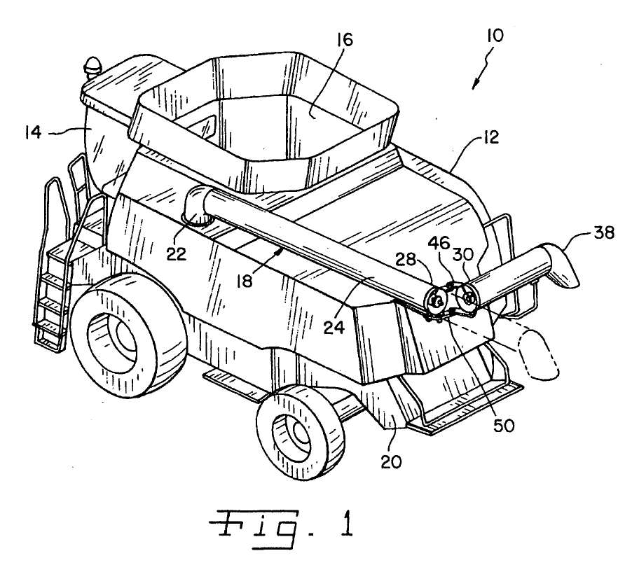

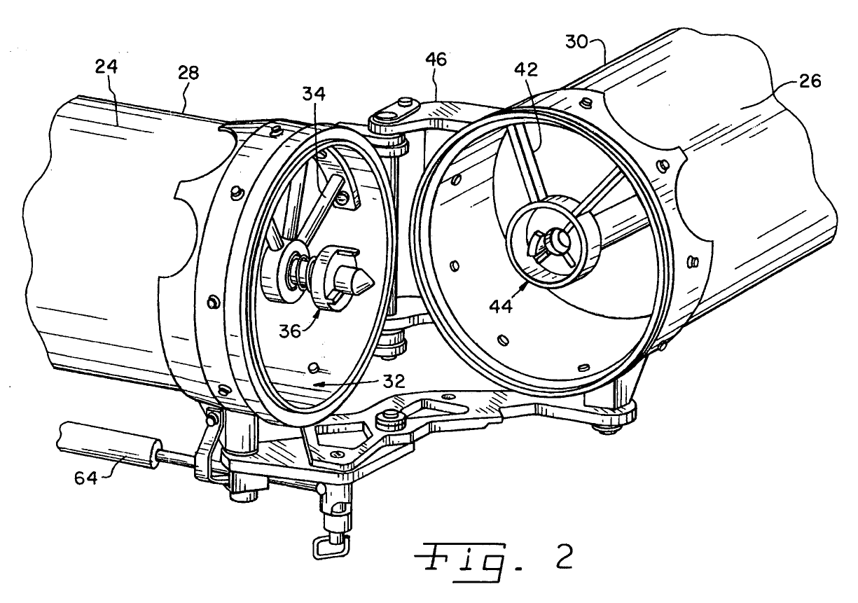

Referring now to the drawings, and more particularly to FIGS. 1 and 2, there is shown an embodiment of an agricultural harvester 10 in the form of an agricultural combine. Harvester 10 generally includes a body 12, operators cab 14, grain tank 16 and unloading auger 18. Harvester 10 is detachably coupled with a cutting platform or head (not shown) in front of operators cab 14. A crop material is transported from the head into a separator within harvester 10, with the grain being transported into grain tank 16 and the non-grain material being discharged back onto the field using straw chopper 20.

Unloading auger 18 is used to unload clean grain from grain tank 16 to a vehicle, such as a semi trailer, gravity wagon, straight truck, etc. Unloading auger 18 pivots about a generally vertical axis (depending upon the orientation of harvester 10) at input end 22 which receives grain from grain tank 16. Unloading auger 18 is configured as a folding unloading auger including an inner auger 24 and an outer auger 26. Inner auger 24 has an outer end 28 which lies adjacent to an inner end 30 of outer auger 26. Inner auger 24 carries a flighting 32 therein (not visible but indicated positionally in FIG. 2), which is held in a generally concentric position within the auger tube by a support structure 34 at outer end 28. A first coupler 36 is also carried by support structure 34, and is axially movable within support structure 34. First coupler 36 is rotatably driven by flighting 32 (and its center support member) within inner auger 24.

Outer auger 26 includes a discharge end 38 from which the grain is discharged into a vehicle. Outer auger 26 also includes a flighting 40 which is rotatably and concentrically supported within the outer tube by support structure 42 at inner end 30. A second coupler 44 also supported by support structure 42 rotatably drives the center support tube carrying flighting 40.

Inner auger 24 and outer auger 26 are pivotally interconnected with a hinge assembly 46 about a generally vertical pivot pin 48. Hinge assembly 46 is located on the side of inner auger 24 and outer auger 26 closest to body 12, such that outer auger 26 may be folded around the rear of body 12, as shown in FIG. 1.

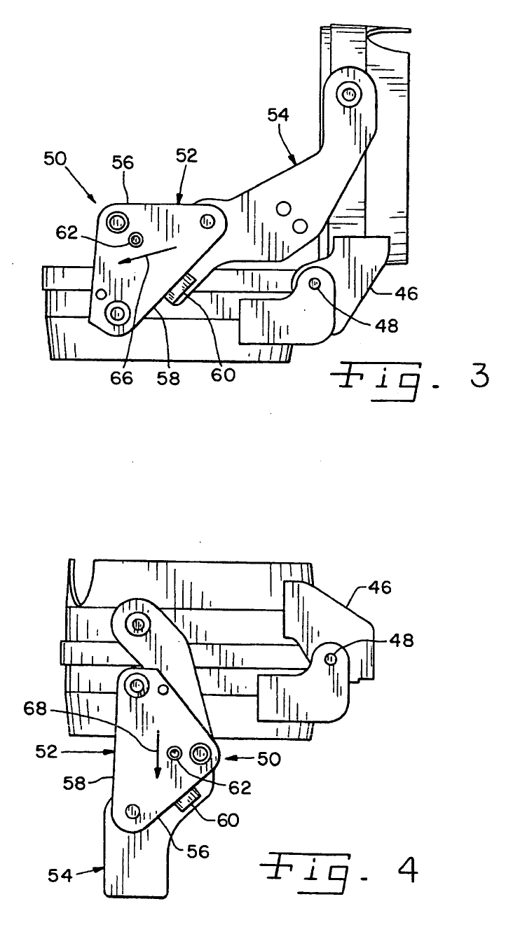

Referring now to FIGS. 2-4, conjunctively, an over center linkage 50 is positioned at the bottom side of and pivotally couples inner auger 24 and outer auger 26. Over center linkage 50 is moveable to a first over center position when outer auger 26 is in an unfolded position (FIG. 4), and moveable to a second over center position when outer auger 26 is in a folded position at the rear of combine 10 (FIGS. 2 and 3). Over center linkage 50 functions to retain outer auger 26 in a substantially rigid position relative to inner auger 24 when outer auger 26 is in either the unfolded or folded position.

More particularly, in the embodiment shown, over center linkage 50 is in the form of a two-bar linkage including a linkage 52 and an other linkage 54. Linkage 52 is pivotally coupled with inner auger 24 and has a generally triangular shape with a first side edge 56 and a second side edge 58. Linkage 54 is pivotally coupled with outer auger 26 and includes a stop member 60 which provides a positive stopping surface against first side edge 56 or second side edge 58 when outer auger 26 is in the unfolded or folded positions, respectively. Stop member 60 abuts first side edge 56 when outer auger 26 is in the unfolded position (FIG. 4), and stop member 60 abuts second side edge 58 when outer auger 26 is in the folded position (FIG. 3).

Linkage 52 also includes an actuator attachment feature 62 which is pivotally coupled with an actuator 64 (FIG. 2) for applying an external force to linkage 52 and thereby locking linkage 52 relative to linkage 54 when outer auger 26 is in either the unfolded or folded positions. The directions of external force application by actuator 64 are illustrated in FIGS. 3 and 4 by directional arrows 66 and 68, respectively. In the embodiment shown, actuator attachment feature 62 is in the form of an attachment hole providing pivotal attachment with actuator 64. Further, in the embodiment shown, actuator 64 is configured as an extendable pole, but may also be configured as an electric actuator, etc.

During harvesting operation, unloading auger 18 is held in the folded position at the rear of body 12 by applying an external force with actuator 64 in the direction of arrow 66 and thereby locking over center linkage in the position shown in FIG. 3. During an unloading operation, the external force applied by actuator 64 is released, outer auger 26 is pivoted to the unfolded position, and inner auger 24 is pivoted to the side of body 12 about input end 22. Outer auger 26 is held in the unfolded position by applying an external force with actuator 64 in the direction of arrow 68 and thereby locking over center linkage in the position shown in FIG. 4. Unloading auger 18 is then actuated to move the grain from grain tank 16, through unloading auger 18 and into a vehicle.

Having described the preferred embodiment, it will become apparent that various modifications can be made without departing from the scope of the invention as defined in the accompanying claims.

1. An unloading auger for an agricultural harvester, comprising:
an inner auger;
an outer auger pivotally coupled with said inner auger, said outer auger movable between an unfolded position and a folded position; and
an over center linkage coupled between said inner auger and said outer auger;
said over center linkage movable to a first over center position when said outer auger is in said unfolded position, and a second over center position when said outer auger is in said folded position.

2. The unloading auger of claim 1, wherein said over center linkage retains said outer auger in a substantially rigid position relative to said inner auger when said outer auger is in each of said unfolded position and said unfolded position.

3. The unloading auger of claim 1, wherein said over center linkage comprises a two bar linkage, one said linkage pivotally attached to one of said inner auger and said outer auger, and an other said linkage pivotally attached to an other of said inner auger and said outer auger.

4. The unloading auger of claim 3, wherein said one linkage has a generally triangular shape with a first side edge and a second side edge, and said other linkage includes a stop member abutting said first side edge when said outer auger is in said unfolded position, and abutting said second side edge when said outer auger is in said folded position.

5. The unloading auger of claim 4, wherein said one linkage includes an actuator attachment feature coupled with an actuator for applying an external force to said one linkage and thereby locking said one linkage relative to said other linkage.

6. The unloading auger of claim 5, wherein said actuator attachment feature comprises an attachment hole.

7. The unloading auger of claim 3, wherein said one linkage is pivotally attached to said inner auger and said other linkage is pivotally attached to said outer auger.

8. The unloading auger of claim 1, further including a hinge assembly pivotally interconnecting said inner auger and said outer auger.

9. The unloading auger of claim 8, wherein said hinge assembly is located on a side of said inner auger and said outer auger, and said over center linkage is located under said inner auger and said outer auger.

10. An agricultural harvester, comprising:
a grain tank; and
an unloading auger in communication with said grain tank, said unloading auger including:
an inner auger;
an outer auger pivotally coupled with said inner auger, said outer auger movable between an unfolded position and a folded position; and
an over center linkage coupled between said inner auger and said outer auger; said over center linkage movable to a first over center position when said outer auger is in said unfolded position, and a second over center position when said outer auger is in said folded position.

11. The agricultural harvester of claim 10, wherein said over center linkage retains said outer auger in a substantially rigid position relative to said inner auger when said outer auger is in each of said unfolded position and said unfolded position.

12. The agricultural harvester of claim 10, wherein said over center linkage comprises a two bar linkage, one said linkage pivotally attached to one of said inner auger and said outer auger, and an other said linkage pivotally attached to an other of said inner auger and said outer auger.

13. The agricultural harvester of claim 12, wherein said one linkage has a generally triangular shape with a first side edge and a second side edge, and said other linkage includes a stop member abutting said first side edge when said outer auger is in said unfolded position, and abutting said second side edge when said outer auger is in said folded position.

14. The agricultural harvester of claim 13, wherein said one linkage includes an actuator attachment feature coupled with an actuator for applying an external force to said one linkage and thereby locking said one linkage relative to said other linkage.

15. The agricultural harvester of claim 14, wherein said actuator attachment feature comprises an attachment hole.

16. The agricultural harvester of claim 12, wherein said one linkage is pivotally attached to said inner auger and said other linkage is pivotally attached to said outer auger.

17. The agricultural harvester of claim 10, further including a hinge assembly pivotally interconnecting said inner auger and said outer auger.

18. The agricultural harvester of claim 17, wherein said hinge assembly is located on a side of said inner auger and said outer auger, and said over center linkage is located under said inner auger and said outer auger.

19. A method of operating an unloading auger in an agricultural combine, comprising the steps of:
unfolding an outer auger relative to an inner auger; and
moving an over center linkage interconnected between said inner auger and said outer auger to a first over center position when said outer auger is in an unfolded position.

20. The method of operating an unloading auger of claim 19, including the step of locking said over center linkage using an actuator when said outer auger is in said first over center position.

21. The method of operating an unloading auger of claim 19, including the steps of:
folding said outer auger relative to said inner auger; and
moving said over center linkage to a second over center position when said outer auger is in a folded position.

22. The method of operating an unloading auger of claim 21, including the step of locking said over center linkage using an actuator when said outer auger is in said second over center position.
